(19) United States
(12) Patent Application Publication
(10) Pub. No.: US 2021/0397700 A1
(43) Pub. Date: Dec. 23, 2021

(54) METHOD AND APPARATUS FOR ISOLATING SENSITIVE UNTRUSTED PROGRAM CODE ON MOBILE DEVICE

(71) Applicant: Technische Universitaet Darmstadt, Darmstadt (DE)

(72) Inventors: Emmanuel Stapf, Muenchen (DE); Patrick Jauernig, Frankfurt am Main (DE); Ferdinand Brasser, Darmstadt (DE); Ahmad-Reza Sadeghi, Darmstadt (DE)

(21) Appl. No.: 17/287,617

(22) PCT Filed: Oct. 2, 2019
(86) PCT No.: PCT/EP2019/076774

§ 371 Date: Apr. 22, 2021

(30) Foreign Application Priority Data
Oct. 10, 2018 (DE) 10 2018 125 073.8
Dec. 19, 2018 (DE) 10 2018 132 970.9

(51) Int. Cl. G06F 21/53; G06F 21/74; G06F 9/50

(52) U.S. Cl. CPC G06F 21/53; G06F 2221/2149; G06F 9/5016; G06F 21/74

(57) ABSTRACT

A method provides isolated and secured execution environments on a terminal controlled by one or more processors having one or more processor cores. The processors execute a first trusted execution environment and a second legacy execution environment. At least one trusted application (4) is executed in the trusted execution environment and processes sensitive data, and a legacy application (2) is executed in the legacy execution environment. Execution environments, called sanctuary instances, are isolated from the first and second execution environments and are executed on a dedicated processor or dedicated processor core. The sanctuary instances may be present physically or virtually. Sanctuary memory areas are assigned to the respective processors or processor cores. At least one sanctuary application (10) is executed in a sanctuary instance, and a sanctuary application (10) interacts with one or more legacy applications (2) and with one or more trusted applications via at least one communication channel.

The invention relates to a method and apparatus for providing isolated and secured execution environments on a terminal controlled by one or more processors having one or more processor cores, wherein the processors provide and execute a first trusted execution environment and a second unprotected execution environment, wherein the trusted execution environment executes at least one trusted application that processes sensitive data, and wherein the unprotected execution environment executes an unprotected application. Another aspect of the invention is a corresponding terminal device.

### BACKGROUND OF THE INVENTION

The security architectures currently used on most ARM-based mobile devices are explained below and are part of the invention. However, the explanations are not limited to the ARM architecture other architectures such as RISC or CISC are also conceivable.

The vast majority of today's mobile devices contain a processor and other hardware components based on an ARM design. Due to the need for secure mobile services such as mobile banking or eID services (The term eID infrastructure refers to the infrastructure required for the realization of secure electronic identification between the owner of an electronic ID card and a service provider via the Internet), the ARM design has been extended to include functionalities that enable the security of the system using an ARM design to be increased.

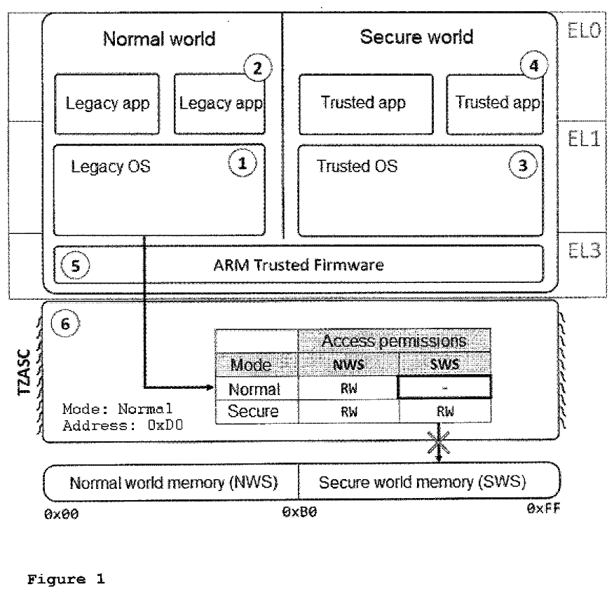

These enhancements affect the processor, memory and other system peripherals and are offered under the name ARM TrustZone. ARM TrustZone enables a subdivision of the system, orthogonal to the privilege levels used to subdivide application, operating system and hypervisor modes, which specifically provides system-wide hardware isolation for trusted software. TrustZone enables mobile device manufacturers to implement security architectures on their devices that allow security-critical program code to run in a trusted environment. This general security architecture, called a Trusted Execution Environment (TEE), is shown in FIG. 1 and is widely used on modern mobile devices.

A TEE provides a secure or trusted execution environment for applications. A TEE can exist isolated on a separate processor, directly on the main processor(s) of a computer system or in a die of a multiprocessor system or a single-chip system (SoC). Only specially enabled applications can be executed on the TEE.

The TEE concept refines the concept of trusted computing. One or more trusted execution environments can exist in parallel, and other insecure or unprotected environments can exist alongside them.

The main feature of a TEE security architecture is the separation of the system into a normal world and a secure world (Normal World/Secure World). The basic idea is that the normal world is generally untrustworthy and therefore potentially malicious. Only program code that does not process sensitive data and is not security-relevant for the system should be executed in this world. On existing architectures, the unprotected OS/operating system (legacy OS) (1) is typically represented by the Android operating system and the unprotected applications (legacy apps) (2) by Android apps. The secure world, on the other hand, runs program code that processes sensitive data and is security relevant to the system. Program code that implements mobile services such as mobile banking or eID should only run in the secure world because it processes sensitive data. It is imperative that code in the secure world is trusted, as it can compromise the entire system. The secure world consists of an operating system, the trusted OS (Trusted OS) (3) and the trusted applications (Trusted Apps) (4) that implement the mobile services. The trusted OS is usually represented by a small custom operating system that can differ significantly between different mobile device vendors.

Switching between normal and secure world is done by a trusted software component named Monitor program code. As a rule, the official reference implementation from ARM, the so-called ARM Trusted Firmware (5), is used. The actual separation between the two worlds is achieved by the TrustZone security extensions for the processor and other peripherals. TrustZone-enabled processors can run in two different security modes, either unsecured or secured. In non-secure mode, the processor can only access program code and data from the normal world. In secure mode, the process can access program code and data from both worlds. The world separation in memory is enforced by a TrustZone-enabled address space controller, the TrustZone Address Space Controller (TZASC) (6). FIG. 1 shows that the TZASC would prevent access from the unprotected OS to memory address 0xD0, for example, because this memory area belongs to the secure world. If a processor also has virtualization extensions, the processor can also enter another mode called hypervisor mode (EL-2 on ARM processors). In this mode, the processor's virtualization mechanisms can be configured.

Although both worlds are strictly separated, communication between the two worlds is necessary to use the functions implemented in the secure world. Typically, the mobile device manufacturer provides trusted applications in the TEE that offer some basic functions, such as secure storage of a key in the secure world or encryption and decryption of data with these keys. In this case, the sensitive data is only processed within the secure world and is therefore not at risk of being stolen by an attacker. These basic provider functionalities can be openly used by any unprotected application in the normal world. However, for most mobile services, the provided functionalities of the provider's trusted applications are not sufficient, because mobile providers use their own algorithms and protocols, e.g. for key management, which process sensitive data and need to be protected at runtime. In a TEE architecture, this is possible by using the TEE's own trusted applications. As a result, a mobile operator would split its program code into sensitive and non-sensitive program code. The sensitive program code is implemented in a trusted application, and the non-sensitive program code is implemented in an unprotected application. When both are deployed on the device, they can work together to provide the mobile service.

In theory, the TEE architecture represents a solid concept. In practice, however, a major drawback of this architecture has developed. Any trusted application developed by an external mobile carrier must be explicitly trusted by the mobile device manufacturer. The reason for this is that the trusted Operating Systems (OSes) cannot be expected to be bug-free. The trusted OSes will generally be smaller than the untrusted OSes. However, they are still complex and large enough that software bugs are very likely, and some of them have already been found in existing implementations. The trust required in the program code of a trusted application is also much higher than the trust a device manufacturer must place in the program code of an unprotected application. If an unprotected application manages to compromise the unprotected OS, it will still not gain access to the sensitive data in the secure world. However, if a trusted application is able to exploit a flaw in the trusted OS, it can compromise the entire system. It gains access to all sensitive data in the secure world and also to all data in the normal world. In practice, this led to the following situation in the mobile software ecosystem:

Some mobile device manufacturers completely lock their TEE to third-party program code so that no malicious or buggy trusted application can be brought to the device and system security is compromised. However, this means that no mobile carrier can run and protect their own sensitive program code in a secure environment. Other mobile device manufacturers allow trusted third-party applications to be deployed to a device. However, this involves a high management overhead that represents a significant investment for a mobile operator, as each device manufacturer must be contacted individually to obtain a customized solution in their TEE.

In addition, all trusted applications must be thoroughly tested to gain trust in them. If a device manufacturer would simplify the deployment process of trusted applications by allowing any trusted application in its TEE, this would severely compromise system security. Although there is a high demand for secure mobile services and ARM TrustZone is available on most mobile devices, secure mobile services protected by TrustZone are not widely available today.

Known from the prior art are:

Intel SGX offers security functionalities, but is only available for the x86 platform—and thus not for mobile devices.

(V. Costan and S. Devadas. Intel sgx explained. IACR Cryptology ePrint Archive, 2016:86, 2016)

Sanctum is similar to SGX, but proposes a completely new platform architecture and is therefore not practical. (V. Costan, I. A. Lebedev, and S. Devadas. Sanctum: Minimal hardware extensions for strong software isolation. in USENIX Security Symposium, pages 857-874, 2016.)

Sancus extends the openMSP430 architecture by adding cryptographic and memory isolation primitives by hardware. Due to the costliness of hardware changes, Sancus is also not practically relevant.

(J. Noorman, P. Agten, W Daniels, R. Strackx, A. Van Herrewege, C. Huygens, B. Preneel, I. Verbauwhede, and F. Piessens. Sancus: Low-cost trustworthy extensible networked devices with a zero-software trusted computing base. in 22nd USENIX Security symposium, USENIX Sec, pages 479-494, 2013.

J. Noorman, J. V. Bulck, J. T. Mühlberg, F. Piessens, P. Maene, B. Preneel, I. Verbauwhede, J. Gotzfried, T. Müller, and F. Freiling. Sancus 2.0: A low-cost security architecture for iot devices. ACM Transactions on Privacy and Security (TOPS), 20(3):7, 2017.)

TrustICE has the same objective as the sanctuary, but does not allow parallel execution of the sensitive program code with the unprotected OS, and requires trust in the sensitive program code, so TrustICE is also not practical. (H. Sun, K. Sun, Y. Wang, J. Jing, and H. Wang. Trustice: hardwareassisted isolated computing environments on mobile devices. in Proceedings of the 2015 45th AnnuaiiEEE/IFIP International Conference on Dependable Systemsand Networks, DSN '15, pages 367-378, 2015.)

Overview of the Invention:

The object is therefore to find a solution for the above problems.

The object is solved by a method and an apparatus according to one or more of the claims.

In particular, by a method for providing secured execution environments on a terminal controlled by one or more processors with one or more processor cores. Here it is to be clarified that physical or virtualized processors or processor cores represent units which are allocated their own memory area and which do not allow any overlap with other applications which are processed on other processors or processor cores. The aim is thus to separate applications at processor or processor core level and memory level.

The processors execute a first trusted execution environment and a second unprotected execution environment, wherein the trusted execution environment executes at least one trusted application that processes sensitive data, and wherein the unprotected execution environment executes an unprotected application. This is the well-known TEE architecture, such as implemented on ARM processors. Other processors have similar architectures. A restriction to processors with a corresponding design is not intended. Execution environments usually run separate operating systems, with separate applications that can only communicate with each other via clearly defined interfaces. By default, applications from the unprotected execution environment communicate with applications in the trusted execution environment via defined protocols and interfaces. The invention is implemented by a corresponding architecture with an appropriate address space controller that separates the memory areas accordingly. Also conceivable is corresponding firmware, which is arranged as a layer between the processor and the address space controller, and coordinates communication with the hardware and between the unprotected execution environment and the trusted execution environment.

The invention has one or more further execution environments, called sanctuary instances, which are isolated from the first and second execution environments and each run on a dedicated processor or dedicated processor core. These are different processors or processor cores than those on which the first two execution environments are running. Further, each sanctuary instance is associated with a sanctuary memory area, which in turn is exclusively associated with that processor or processor core.

A sanctuary instance usually also runs a small operating system that is able to provide applications with the appropriate hardware resources. This operating system is minimized and dedicated to the purpose of running specific sanctuary applications.

In particular, libraries can be provided in a sanctuary instance that can be used by the sanctuary applications to enable interaction with the unprotected execution environment and/or the trusted execution environment. Here, the sanctuary library provides the necessary communication channels. This library is also used for protection to restrict malicious sanctuary applications in their access. Here, the unprotected execution environment is designed or the applications running in the unprotected execution environment are designed in such a way that communication does not take place directly with the trusted application in the trusted execution environment; instead, communication first takes place with the sanctuary applications, which in turn communicate with the applications in the trusted execution environment. For example, when the unprotected application makes a communication request to the trusted application, the communication request is redirected to the sanctuary application, which then processes the communication request while performing a communication with the trusted application.

Communication of the unsecured execution environment with a sanctuary instance can be done either automatically by appropriate kernel modules or the applications use appropriate libraries and routines provided in the unsecured execution environment to enable communication with the sanctuary.

It should be noted that applications in a sanctuary instance do not necessarily need to access applications in the trusted execution environment. They can also run on their own in a sanctuary instance.

Preferably, the software, including the trusted OS and the trusted applications running on the trusted OS, can no longer be changed after the initial configuration of the terminal, or can only be changed with great effort. This means that at the time of delivery to the end customer, there is no update option for the end customer himself. This is to ensure that software can no longer be changed in the trusted execution environment at the end customer's site, or that changes can only be made with the help of the terminal manufacturer. This ensures that an attack on software is severely restricted on the hardware side.

Since errors in the trusted execution environment must also be corrected, the terminal manufacturer has the option of updating it. In order to be able to respond to adjustments to the trusted execution environment and to be able to fix their own bugs, the sanctuary applications are also replaceable by end users or third-party vendors developing sanctuary applications after delivery of the terminal. This enables a faster response to errors and greater independence from the terminal manufacturer.

The exchange can take place either via a radio network or by installing software via cable connections. The exchange can affect only the sanctuary applications as well as the operating system running in a sanctuary instance or the corresponding libraries.

In a preferred embodiment, the trusted execution environment executes an application, preferably as a kernel module, that verifies that a sanctuary instance is set up correctly to allow communication with the applications in the trusted execution environment only if there is a correct setup of the sanctuary instance.

This verification can be based on signatures or hash values. This ensures that interaction only takes place if a sanctuary instance or its applications have not been corrupted. The corresponding signatures or hash values can be stored in the trusted execution environment and retrieved from the network, for example. Thus, it can be ensured that the integrity of the device is given. Also, for example, the execution of a sanctuary instance can only take place after a verification has been successfully performed.

In a preferred embodiment, a sanctuary instance provides a sanctuary library that provides basic process and memory management, and communication functions, particularly to communicate with the trusted application and the unprotected applications. Thus, the scope of sanctuary application programming is reduced and communication is standardized, which can reduce malicious attacks.

In the preferred embodiment, the terminal is a mobile terminal as used in known cell-based mobile networks comprising GSM and LTE. Thus, the sanctuary applications are exchangeable, for example, after delivery of the terminal device by a cellular network operator via the cellular network. For example, the exchange of applications in a sanctuary instance may be controlled such that only applications running in the trusted execution environment are authorized to perform overwriting of applications in a sanctuary instance. It is also conceivable that the applications in a sanctuary instance themselves periodically check for updates to replace themselves. The applications in the trusted execution environment then check whether the updates are allowed or not. Due to the fact that the trusted applications can only be accessed via a sanctuary instance, it is ensured that an immediate attack on the trusted applications is prevented.

A sanctuary instance is preferably assigned to and executed on a physical or virtualized processor or processor core. The processor or processor core is selected based on processor identifiers, for example. The sanctuary memory area is allocated exclusively to this processor or processor core. The sanctuary instances, the unprotected execution environment, and the trusted execution environment are isolated from each other by appropriate isolation mechanisms. Isolation is accomplished by controlling access to the memory areas allocated to each of the sanctuary instances, the unprotected execution environment, and the trusted execution environment. Access control of the memory areas of the unprotected and trusted execution environments is implemented by an address space controller, as in the prior art (e.g., ARM's TZASC). If a sanctuary instance is assigned to a physical processor or processor core, isolation of the sanctuary instance is also realized by an address space controller. If a Sanctuary instance is assigned to a virtualized processor or processor core, isolation is implemented by virtualization mechanisms of the physical processor or processor core (e.g., an appropriately formed Memory Management Unit (MMU)). The sanctuary isolation mechanisms control that applications from the unprotected execution environment are only granted access to the portion of the sanctuary memory area that is to be shared with the unprotected execution environment. Further, the address space controller controls that sanctuary applications can only access the portion of the trusted execution environment memory area that is to be shared with the sanctuary instance.

In a preferred embodiment, the sanctuary applications can now interact with applications in the unprotected execution environment and with applications in the trusted execution environment using the sanctuary library, via the shared memory areas.

In a preferred embodiment, a sanctuary instance is built and executed only when there is a communication request from an unprotected application. After a sanctuary instance completes its execution, it may terminate itself, or it may be terminated and terminated by either the unprotected or trusted execution environments when certain timing or other conditions regarding its use have occurred. In this case, the resources that have been claimed by a sanctuary instance can be released. On the other hand, when a sanctuary instance is to be built, appropriate resources are to be allocated so that a processor or a processor core is available only for the sanctuary instance. The same applies to the memory area.

In the build/initialization of a sanctuary instance, components of the trusted execution environment as well as components of the unprotected execution environment are involved.

The components of the unprotected execution environment load the sanctuary library and sanctuary applications into memory, and initiate the build process. They also select the processor or processor core to be assigned to a sanctuary instance. The components of the trusted execution environment verify the correctness of the build. If the sanctuary instance is bound to a physical processor or processor core, the trusted execution environment activates memory isolation, i.e. it configures the address space controller accordingly. If the sanctuary instance is bound to a virtualized processor or processor core, a processor of the terminal switches to hypervisor mode and activates memory isolation by configuring the virtualization mechanisms (e.g., a corresponding MMU) of the processor or processor core assigned to the sanctuary instance accordingly.

Another part of the invention is a terminal device having corresponding processors, memory, durable storage media and architecture to perform the aforementioned method. Typically, these are known mobile terminals whose firmware and software configuration must be adapted to perform the method. However, it can also be servers or personal computers that have corresponding firmware.

Figures Description:

FIG. 1: Overview of the TEE architecture

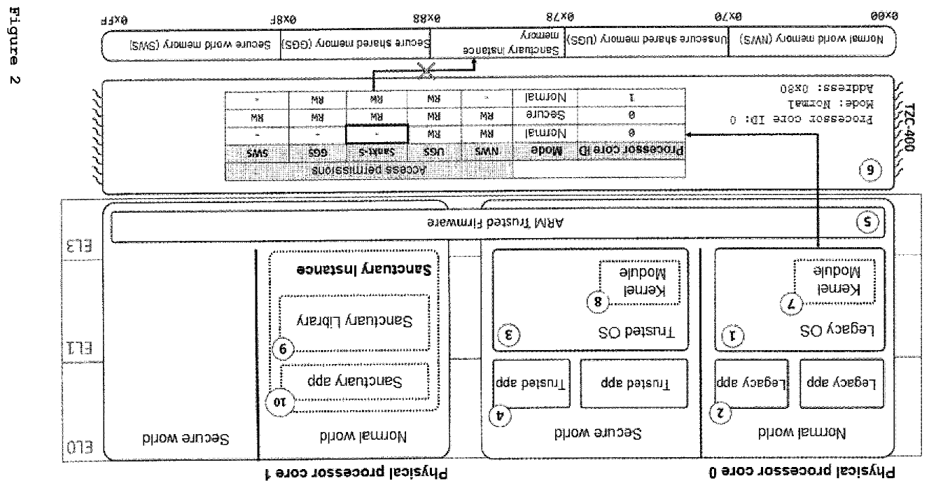

FIG. 2: Overview of the architecture of the present invention when a sanctuary instance is assigned to a physical processor core, the dashed lines represent the new components.

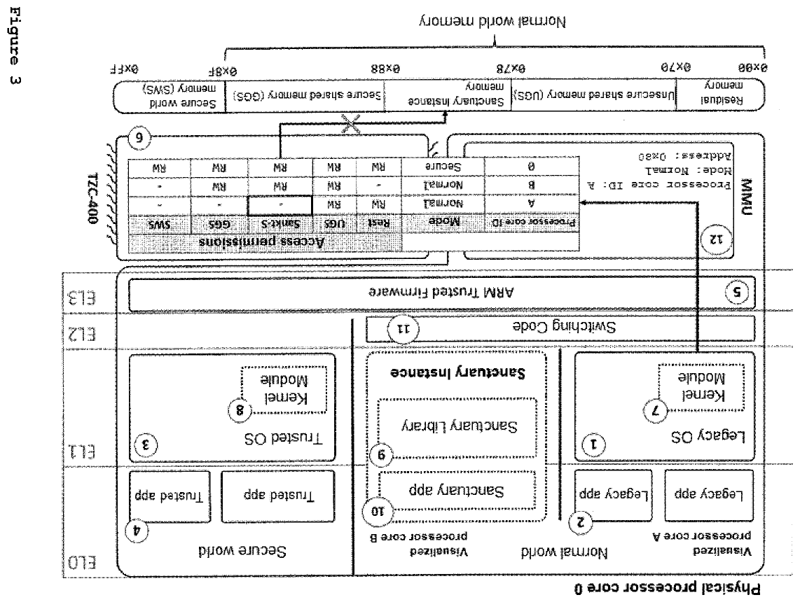

FIG. 3: Overview of the architecture of the present invention when a sanctuary instance is assigned to a virtualized processor core. The dashed lines represent the new components.

The basic idea of a sanctuary design is to provide one or more isolated execution environments in which sensitive program code that processes sensitive data can be executed. These isolated environments are called sanctuary instances. The program code running in a sanctuary instance is completely separated from all untrusted program code on the system, and at the same time it is not part of the system's trusted program code, also referred to as a Trusted Computing Base (TCB). In fact, the program code running in a sanctuary instance need not itself be trusted, as it cannot compromise system security. Separation from trusted program code and other untrusted program code is accomplished by running each Sanctuary instance on a dedicated processor or processor core and allocating memory areas exclusively to those processors or processor cores using appropriate isolation mechanisms.

In practice, the sanctuary design can be used, for example, to extend existing TEE architectures so that the full potential of TEEs can finally be exploited on modern mobile devices. FIG. 2 shows a generic TEE architecture extended by the design principles of the sanctuary when a sanctuary instance is assigned to a physical processor core. FIG. 3 shows an extended TEE architecture when a sanctuary instance is assigned to a virtualized processor core.

As in the traditional TEE architecture, the system is divided into a normal world and a secure world (Normal World/Secure World). In the normal world, the untrusted program code consists of the unprotected OS (Legacy OS) (1) and the unprotected applications (Legacy Apps) (2). In the secure world, a trusted OS (Trusted OS) (3) is executed along with trusted applications (Trusted Apps) (4). One of the important differences from the state of the art TEE architecture is that the secure world will not contain any program code from a third party vendor. All trusted applications in the TEE will be provided by the device manufacturer or by the TEE provider if developed by a second trusted party. It is up to the manufacturer to decide which functionalities to provide in the TEE. A change after delivery to the end customer is thus not possible or only possible with a very high effort.

The sensitive third-party code that had to be integrated into the TEE in the form of a custom trusted application is isolated in a sanctuary instance in the form of a sanctuary app (10). This means that instead of a custom trusted application, a mobile operator now develops a custom sanctuary application. For each sanctuary application, there is preferably a corresponding unprotected application, which can also be developed by the mobile network provider or by third parties accessing standard interfaces, for example.

The sanctuary instance comprises a sanctuary application and a sanctuary library 9. The sanctuary library provides some basic process and memory management functions for the sanctuary application, e.g., running with unprivileged rights in the sanctuary instance. In one possible embodiment, the design principles of a sanctuary instance require that no more than one sanctuary application from different providers run in the sanctuary instance at the same time to prevent data leakage between different mobile services. Running multiple sanctuary applications from the same provider in a sanctuary instance, on the other hand, is possible in the sanctuary design.

As shown in FIG. 2 and FIG. 3, the sanctuary code runs on a separate processor core and is therefore separated from the untrusted/unsecured program code of the normal world. If the sanctuary instance is assigned to a physical processor core, as shown in FIG. 2, the sanctuary memory area is also preferably separated from the rest of the system by the TZASC hardware component (6). The latest reference implementation, the TZC-400, allows memory areas to be allocated exclusively to bus masters on the system that identify themselves in the transactions they send over the system bus. The CPU, GPU, and other peripherals such as a display controller act as bus masters on the system. The TZC-400 can now use the identifiers sent by the bus masters to perform memory access control. In current TEE architectures, this feature of the TZC-400, called identity-based filtering, is only used to implement media protection applications where memory is allocated to either the CPU or the GPU. In the sanctuary design, this feature is used to allocate an area of memory exclusively to the one physical processor core on which the sanctuary code is to be executed. As a result, the processor cores executing the normal world program code cannot access the memory areas of the sanctuary instances. Since the identity-based filtering feature is not implemented in cache memory, at least so far, the sanctuary code and its data are not cached in the shared cache memory between the processor cores of the same processor cluster. Otherwise, program code in the normal world could gain access to data from a sanctuary instance. On ARM-based systems, this shared cache is typically the L2 cache.

If the sanctuary instance is assigned to a virtualized processor core, as shown in FIG. 3, the sanctuary memory area is preferably separated from the rest of the system by virtualization extensions, e.g. an appropriately designed MMU 12. Since the ARMv7 architecture, corresponding virtualization mechanisms are available for ARM processors. The memory access control of the MMU is performed by a two-stage translation from virtual memory addresses to physical memory addresses. The configuration of the MMU can only be done in the privileged hypervisor mode EL2 and is performed by the switch program code 11. In this way, the normal world program code running in lower privileged modes (EL0 or EL1) can no longer configure the MMU and therefore cannot access the memory area of the sanctuary instance. Since the virtualization mechanisms are also implemented in the cache, the sanctuary code and its data can also be stored in the cache memory.

Sanctuary instances are not always executed or configured in the system. Only when an unprotected application requests to run the sensitive program code of its corresponding sanctuary application, a sanctuary instance is set up and deployed. This saves resources on the system. Sanctuary instances are set up and managed mainly by the new kernel modules (Kernel Modules), components that are part of the unprotected OS (7) and the trusted OS (8). The kernel module of the unprotected OS is mainly used for collecting the needed resources from the unprotected OS. It selects a processor kernel to be used as the sanctuary kernel and loads the sanctuary application and sanctuary library binaries into memory. All security-related management tasks are performed by the trusted OS's kernel module. The kernel module of the trusted OS ensures that a sanctuary instance is actually separated from the other untrusted program code on the system. It checks the sanctuary library binary and ensures that the sanctuary instance is set up correctly. In addition, the kernel module of the trusted OS configures the isolation mechanism used. If the sanctuary instance is to be assigned to a physical processor core, as shown in FIG. 2, the kernel module configures the TZASC component. In addition, the help of the ARM Trusted Firmware TF is needed to verify that the selected physical sanctuary core has been shut down properly. If the sanctuary instance is to be assigned to a virtualized processor core, as shown in FIG. 3, the kernel module calls the switch program code 11 to configure the MMU. After configuring the isolation mechanism and checking the sanctuary library, the sanctuary instance can be started. This is triggered by the kernel module of the unprotected OS. If the sanctuary instance is run on a physical processor core, the kernel module uses the ARM TF to launch the sanctuary core. If the sanctuary instance is run on a virtualized processor core, the kernel module uses the switch program code to trigger the execution of the sanctuary code.

When a sanctuary instance is up and running, the sanctuary application can communicate with the corresponding unprotected application to receive commands or non-sensitive data from it. In addition, it can use all the trusted functionalities of the device manufacturer and its trusted applications. This means that a sanctuary application can extract sensitive data from the TEE and then process it in an isolated environment provided by the sanctuary instance. Using the kernel module in the trusted OS, a trusted application can always ensure that sensitive data is only shared with a properly established sanctuary instance and with the legitimate sanctuary application that owns the data. Once the sanctuary application has processed the sensitive data, it can be stored back in the TEE and non-sensitive processing results can be returned to the unprotected application. At the point a sanctuary application is installed on a device, it will never contain sensitive data. All sensitive data is made available while the sanctuary application is running. To achieve this, the TEE provides a mechanism with its proven functionalities that allows a remote server or a local program to verify the correct state of a sanctuary application.

The sanctuary application communicates with its unprotected application or a trusted application through shared memory areas, while the shared memory area between the unprotected application and the sanctuary application is called unprotected shared memory and the shared memory between the sanctuary application and the trusted application is called protected shared memory. Since the protected shared memory may contain sensitive data, it is protected by the isolation mechanism used (TZASC hardware component or MMU with virtualization extensions). FIG. 2 and FIG. 3, respectively, show as an example that the processor core with ID 0 and A, respectively, in normal mode, is denied access to memory address 0x80 because this memory area is allocated to the sanctuary instance.

When a sanctuary instance is no longer needed and is closed on behalf of the unprotected application, the kernel modules of the unprotected and trusted OS work together to dismantle the sanctuary instance in such a way that no data from inside the sanctuary instance can be picked up by the program code of the normal world. All resources taken from the unprotected OS are returned.

The Sanctuary design can be used to solve the problems of existing TEE architectures. By moving the third-party sensitive program code from the secure world to Sanctuary instances, each mobile vendor can obtain from the device manufacturer the ability to transfer its own sensitive program code to the devices. The reason for this is that all Sanctuary code is not part of the system's TCB, which means that the mobile device manufacturer does not have to trust this program code. The sanctuary code has no privileged rights on the system and yet is completely isolated from other untrusted program code. The isolation works both ways. The program code of the normal world cannot access the memory areas of the sanctuary instances, and the program code of the sanctuary instances cannot access the memory area of the normal world. Therefore, the sanctuary design even covers the notion of a malicious sanctuary application. A malicious trusted application, on the other hand, is not covered by current TEE architectures. Because of these design features, deploying sanctuary applications can be as simple as deploying traditional unprotected applications because extensive safety assessments of sanctuary applications are not required. Because the sanctuary design is flexible and introduces only a few new components, most existing TEE solutions can be modified to implement the sanctuary design.

A possible test implementation of the sanctuary design followed the sanctuary architecture shown in FIG. 2. A Linux is used as the unprotected OS (1), while the unprotected applications (2) are represented by C programs running on the Linux kernel in user space. The Linux kernel has been extended with its own kernel module (7). For example, the open-source TEE called OP-TEE was used as a trusted OS (3), which also allows the implementation of trusted applications (4). OP-TEE was extended with its own kernel module (8). For the sanctuary library (9), the Zircon microkernel was used because of its relatively small size of 1 MB and because it provides a full userspace environment. The sanctuary applications (10) are written as C programs running on the Zircon microkernel. A slightly modified version of the ARM Trusted Firmware was used as monitor program code.

In the test implementation, two trusted applications were implemented that provide some basic trusted functionality needed to implement most mobile services on a device. One trusted application provides some remote certification functionality that can be used to verify the state of a sanctuary application from a remote server. As mentioned earlier, this functionality is needed to transfer sensitive data to the device. The second trusted application provides some sealing functionality that can be used to securely and permanently store any data from a sanctuary application on the device. This trusted application also ensures that only the authorized sanctuary application can extract its stored data. In the test implementation, the real-world scenario of a one-time password (OTP) generator application, which is widely used for two-factor authentication, was implemented. The application consists of an unprotected component in the normal world and a sanctuary application. Using the two trusted applications, the generator application can request a secret key from a remote server and then keep it secure. At a later time, the sanctuary application can generate a new OTP using the key and the current timestamp, which is then sent to the unprotected component of the generator application and displayed to the user who wants to perform two-factor authentication.

Since the OTP generation algorithm processes sensitive data (the secret key), this must be protected at runtime. In current TEE architectures, a separate trusted application would be required in the TEE. This implementation has shown that the same can be achieved with the sanctuary design without the need for third-party code in the TEE. The implementation evaluation shows that the sanctuary architecture is practical and does not cause a high performance loss.

Important for the implemented variant where the sanctuary instance is bound to a physical processor core is that the memory separation is enforceable on a per-core basis in hardware.

The reason for this is that the identifiers assigned to the various bus masters in the system are assigned in hardware and cannot be changed via software. Through experiments with virtualization tools from ARM, the so-called ARM Fast Models, it was found that unique identifiers can be assigned to each processor core with minimal effort when designing the hardware of a mobile device. In addition, a filter mechanism can be used to transfer these identifiers to all transactions of the bus masters that send them over the system bus.

### LIST OF REFERENCE SIGNS

1 Unprotected OS (Legacy OS)
2 Unprotected application (Legacy App)
3 Trusted OS (Trusted OS)
4 Trusted application (Trusted App)
5 ARM Trusted Firmware
6 Trust Zone Address Space Controller (TZASC)
7 Kernel Module (Kernel Module)
8 Kernel Module (Kernel Module)
9 Sanctuary Library (Sanctuary Library)
10 Sanctuary App (Sanctuary App)
11 Switching program code (Switching Code)
13 Memory Management Unit (MMU)

1. A method for providing isolated and secured execution environments on a terminal controlled by one or more processors having one or more processor cores, said processor providing and executing a first trusted execution environment and a second unprotected execution environment, said trusted execution environment executing at least one trusted application processing sensitive data, and said unprotected execution environment executing an unprotected application, wherein:
one or more further execution environments, called sanctuary instances, which are isolated from the first and second execution environments and are each executed on a dedicated processor or dedicated processor core, which may be present physically or virtualized, and a sanctuary memory area exclusively allocated to the respective processor or processor core, wherein in a sanctuary instance at least one sanctuary application is executed, wherein a sanctuary application interacts with both one or more unprotected applications and one or more trusted applications via at least one communication channel, wherein when the unprotected application makes a communication request to the trusted application, the communication request is redirected to the sanctuary application, which then processes the communication request while performing a communication with the trusted application.

2. The method of claim 1, wherein the sanctuary application is replaceable after delivery of the terminal, wherein the trusted application is replaceable in the trusted execution environment at the end customer only with the help of a manufacturer of the terminal.

3. The method of claim 1, wherein the terminal is a mobile terminal for a mobile radio network, in particular for GSM and LTE, and the sanctuary application is exchangeable via the mobile radio network after delivery of the terminal by an operator of the mobile radio network.

4. The method of claim 1, wherein the trusted execution environment executes at least one trusted application that provides functionality that is not for the purpose of managing, in particular provisioning, the sanctuary instances.

5. The method of claim 1, further comprising providing a sanctuary library (9) for the sanctuary application, the sanctuary library providing basic process and/or memory management functions, in particular to interact, in particular to communicate, with the trusted application.

6. The method of claim 1, wherein the sanctuary library is suitably configured to restrict malicious access to basic process and/or memory management functions.

7. The method of claim 1, wherein the sanctuary memory area is separated from the unprotected execution environment by a hardware memory access control component, in particular by an address space controller, and is allocated exclusively to the processor or processor core on which the sanctuary instance is executed.

8. The method of claim 1, wherein the communication of the sanctuary application using the sanctuary library with a trusted application is via shared memory areas, wherein the shared memory areas between the sanctuary library and the trusted application are protected by the address space controller.

9. The method of claim 1 a sanctuary instance is established and executed only on demand, in particular when a communication request to the trusted application is present, only then a sanctuary instance is established by a component, preferably using a kernel module in the unprotected execution environment.

10. The method of claim 9, wherein the kernel module (7) selects the processor or processor core to be used for the sanctuary instance and loads the sanctuary library and sanctuary application binaries, and then initiates the communication.

11. The method of claim 1, wherein, in the trusted execution environment, a component is executed, preferably as a kernel module, which checks whether a sanctuary instance is correctly set up and only allows communication with a trusted application if there is a correct set up of the sanctuary instance.

12. The method of of claim 1, wherein the processor or processor core uses an RISC instruction set.

13. The method of claim 1, wherein the trusted execution environment is realized by a separate processor extension which, in addition to privilege levels used to subdivide into application, operating system and hypervisor modes, enables a further, orthogonal subdivision which in particular provides system-wide hardware isolation for trusted software, preferably implemented by an ARM TrustZone.

14. A terminal or mobile terminal comprising means and equipment for carrying out the method of claim 1.
